(19) United States
(12) Patent Application Publication
(10) Pub. No.: US 2021/0022332 A1
(43) Pub. Date: Jan. 28, 2021

(54) METHOD FOR INSECT REPELLING AND APPARATUS USING THE SAME

(71) Applicant: Yeow Hwee CHONG, Singapore (SG)

(72) Inventor: Yeow Hwee CHONG, Singapore (SG)

(21) Appl. No.: 17/068,054

(22) Filed: Oct. 12, 2020

Related U.S. Application Data
(63) Continuation of application No. PCT/SG2018/050184, filed on Apr. 11, 2018.

(51) Int. Cl. A01M 29/10

(52) U.S. Cl. CPC A01M 29/10; A01M 2200/012

(57) ABSTRACT

A method for insect repelling and an apparatus using the same are provided. The disclosed apparatus comprises a housing; an electromagnetic radiation generating module having a first radiation source being capable of emitting a first electromagnetic wave and arranged on the housing such that the electromagnetic radiation generating module uses the first electromagnetic wave to provide a radiation to the defined area or space; the first electromagnetic wave being an infrared in the wavelength of 700 nm to 1 mm, an ultraviolet in the wavelength of 10 nm to 400 nm or a spectrum-specific visible light in the wavelength of 490 nm to 580 nm; and a controller module residing within the housing to electronically communicate with and control the electromagnetic radiation generating module. Preferably, the radiation is pulsed at a predetermined frequency.

### CROSS-REFERENCE TO RELATED APPLICATIONS

The application is a continuation of International Application No. PCT/SG2018/050184, filed on Apr. 11, 2018, the entire contents of which are incorporated herein by reference.

### TECHNICAL FIELD

The present disclosure relates to a method for repelling a target insect type free from using any chemical entities, natural or synthetic-based. More particularly, the disclosed method utilizes one or more electromagnetic waves of a specific spectrum for interfering perception of the target insect type and deterring the interfered insect type from entering a defined area or space subjected to the radiation of the utilized electromagnetic wave. An apparatus operable to repel insect based upon the disclosed method is described in the present disclosure as well.

### BACKGROUND

Insects such as mosquitoes are transmitting agents for different human diseases. Diseases which can be easily spread through mosquitoes are malaria, dengue, West Nile virus, chikungunya, yellow fever, filariasis, encephalitis, and Zika fever. All these diseases not only take heavy toll on the health of the general population once transmitted, but can be life threatening also towards affected subjects with relatively poor immune system. To prevent and control outbreak of mosquitoes-borne diseases, it is important to minimize contact between mosquitoes and the human subject thus reducing the likelihood of disease transmission through biting of the mosquitoes. Repellants of synthetic or natural origin have been long used to deter or avoid landing of the mosquitoes upon applying the repellant onto a given surface. N,N-diethyl-m-toluamide (DEET), which was developed more than half a decade ago, remains an effective chemical entity for warding off mosquitoes and the like insects. Other chemical compounds with similar impact against mosquitoes are picaridin, permethrin, geraniol, etc. Despite their outstanding performance, chemical-based repellants are far from the perfect solution in providing long term and reliable result shielding people from being bitten by the mosquitoes. For instance, repellency of the chemical-based repellant wanes off progressively over time that 100% repellency may only last for 30 minutes to around 2 hours. In order to stay protected, users have to re-apply the chemical repellant from time to time. Having the re-application doses missed, which happens in almost all the cases where user will only re-apply the repellant again after being bitten by the mosquitoes, can subject the user to the risk of catching the undesired diseases. Moreover, it is always advisable not to use the chemical repellant on kids or infants below certain age to avoid potential adverse effect arisen thereof.

To address at least some of the abovementioned shortcomings in the conventional repellant spray, different insect repelling instruments or means have been developed. For example, Chien has disclosed a device capable of constantly vaporizing insect repelling incense kept in a storage medium through heat for warding off the insect including mosquitoes thereby in U.S. Pat. No. 5,168,654. Another mosquito repelling apparatus is described in U.S. Pat. No. 6,392,549 in which the apparatus can either emit female mosquitoes-repelling sound waves or dispense mosquitoes killing incense by way of heat vaporization. Ketcha et al offers another similar portable insect repelling device in U.S. Pat. No. 7,168,630. China patent publication no. 202857652 has embodied a portable insect repelling device in the form of bracelet on which one or more apertures are fabricated to intermittently release insect repelling chemical. Most of the aforesaid devices or apparatus fight off the mosquitoes utilizing chemical compounds or incense that long term exposure to these chemical compounds is a persistent concern among the users. More importantly, the chemical incense discharged into the air is not fitting for fencing or repelling mosquitoes off a defined spot in an open air area which can be laid open to constant gust of winds blowing off the discharged incense. Correspondingly, these devices cannot be implemented to safeguard entrance of a building or house to prohibit the mosquitoes or other insect from accessing into the building or house. Therefore, an insect repelling method or device free from at least some of the deficiencies found in the above referred devices is greatly desired.

### SUMMARY

The present disclosure aims to provide a chemical-free method for repelling insects such as mosquitoes, flies and/or the like away from a defined area or space. Particularly, the disclosed method employs an electromagnetic wave of a desired spectrum to generate a radiation towards the defined area or space or space. The radiation interferes perception of the affected insect about the defined area or space hence driving the interfered insect off the defined area or space.

Another object of the present disclosure is directed to an insect repelling method towards a defined area or space efficiency of which is less adversely influenced or affected by environmental factor such as windy situation at the defined area or space sought to be protected.

Further object of the present disclosure is to offer an insect repelling method exhibiting minimal invasion towards senses of the user or people located within the defined area or space subjected to the repelling method. In more particular, the frequency of the electromagnetic wave used in the disclosed method is adjustable in relation to the lighting condition of the defined area or space and the adjustment in the frequency used for the radiation poses fewer irritations towards the senses of the people or users.

Still, another object of the present disclosure is to supply a device, an instrument or an apparatus operable in repelling insect for a given area through radiation towards the given area with electromagnetic wave of selective spectrum.

Further object with respect to the disclosed apparatus is directed to enhanced portability. By improving the portability, the disclosed apparatus can be attached, fastened, pinned, or hooked onto the clothing of the user to provide the needed irradiation to a body part which protection against mosquitoes is sought.

At least one of the preceding objects is met, in whole or in part, by the present disclosure, through at least one of the embodiments which relate to a method for repelling insect in a defined area or space. The disclosed method comprises the steps of providing an electromagnetic radiation generating module comprising a first radiation source capable of emitting a first electromagnetic wave, the first electromagnetic wave being an infrared in the wavelength of 700 nm to 1 mm, an ultraviolet (UV) in the wavelength of 10 nm to 400 nm or a spectrum-specific visible light in the wavelength of 490 nm to 580 nm; and subjecting the defined area or space to a radiation using the first electromagnetic wave according to a lighting condition of the defined area or space, the lighting condition being one of absence and presence of an environmental visible light. Particularly, the radiation is pulsed at a predetermined frequency or the first radiation source is being rotated to create a pulsation effect of the radiation at the predetermined frequency.

In more embodiments of the method, the electromagnetic radiation generating module further comprises a second radiation source capable of emitting a second electromagnetic wave that the second electromagnetic wave is different from the first electromagnetic wave. The second electromagnetic wave is an infrared in the wavelength of 700 nm to 1 mm, an ultraviolet in the wavelength of 10 nm to 400 nm or a spectrum-specific visible light in the wavelength of 490 to 580 which are applicable to ward off the defined area or space from insects such as mosquitoes under the correct environmental lighting condition.

In other embodiments, the method may comprise the step of switching the radiation from using the first electromagnetic wave to the second electromagnetic wave or vice versa according to the lighting condition. The switching step can be carried out automatically through one or more sensors equipped with the capabilities to detect the environmental lighting condition. It is important to note that the second radiation source may be rotated to create the pulsation effect of the radiation at the predetermined frequency similar to the rotation of the first radiation mentioned earlier.

In several embodiments, the disclosed method may have the radiation being pulsated at a predetermined frequency to enhance interference towards visual and/or heat senses of the target insect yet minimizing power consumption in providing the radiation.

In more embodiments, the first electromagnetic wave is the infrared in the absence of the environmental visible light or the first electromagnetic wave is the spectrum-specific visible light in the presence of the environmental visible light.

For some preferred embodiments, the first and/or second radiation source has an intensity of at least 0.2 to 3 watt.

Another aspect of the present disclosure includes an apparatus for repelling insect in a defined area or space generally based upon the method set forth above. The defined area or space preferably has a lighting condition associated to the surrounding environment.

In more specific, the apparatus comprises a housing; an electromagnetic radiation generating module having a first radiation source being capable of emitting a first electromagnetic wave and arranged on the housing such that the electromagnetic radiation generating module uses the first electromagnetic wave to provide a radiation to the defined area or space; the first electromagnetic wave being an infrared in the wavelength of 700 nm to 1 mm, an ultraviolet in the wavelength of 10 nm to 400 nm or a spectrum-specific visible light in the wavelength of 490 nm to 580 nm; and a controller module residing within the housing to electronically communicate with and control the electromagnetic radiation generating module. Preferably, the controller module is configured to have the radiation pulsing at a predetermined frequency

For several embodiments of the disclosed apparatus, the electromagnetic radiation generating module further comprises a second radiation source capable of emitting a second electromagnetic wave that the second electromagnetic wave is different from the first electromagnetic wave, the second electromagnetic wave is infrared in the wavelength of 700 nm to 1 mm, an ultraviolet in the wavelength of 10 nm to 400 nm or a spectrum-specific visible light in the wavelength of 490 nm to 580 nm.

In few preferred embodiments, the apparatus may include a fastening member being fabricated on the housing and configured to allow attachment or positioning of the fastening member to a platform for providing the radiation.

In more embodiments of the disclosed apparatus, the electromagnetic radiation generating module further comprises a third radiation source capable of emitting a third electromagnetic wave that the third electromagnetic wave is similar to the first electromagnetic wave and the third electromagnetic wave has peak irradiance greater than or corresponding to the first electromagnetic wave.

For some embodiments, the radiation is switchable from using the first electromagnetic wave to the second electromagnetic wave or vice versa through the controller module according to the lighting condition.

Still, in several embodiments, the predetermined frequency is at least 0.167 hertz.

For a number of embodiments, the radiation facilitates insect repelling in the defined area or space using the infrared or ultraviolet in the absence of an environmental visible light or using the spectrum-specific visible light in the presence of the environmental visible light.

### BRIEF DESCRIPTION OF DRAWINGS

Other advantages and benefits will become apparent to those of ordinary skill in the art upon reading the following detailed description of the preferred embodiments. The drawings are only for the purpose of illustrating preferred embodiments and are not to be construed as limiting the disclosure. Moreover, the same reference numerals are used throughout the drawings to refer to the same parts. In the drawings:

FIG. 1(a) shows the perspective view of one embodiment of the disclosed apparatus for repelling insects such as mosquitoes and FIG. 1 (b) shows the back view thereof;

FIG. 2 shows explosive view of the embodiment illustrated in FIG. 1(a) and FIG. 1(b);

FIG. 3 shows illustrate another embodiment of the disclosed apparatus with a fastening clip to attach the disclosed apparatus to platform or human subject to prevent mosquitoes from approaching; and

FIG. 4(a), FIG. 4(b), FIG. 4(c), FIG. 4(d) and FIG. 4(e) illustrate various implementations of the disclosed apparatus and method in daily life for driving mosquitoes off a defined area or space.

### DETAILED DESCRIPTION OF THE EMBODIMENTS

The presently preferred embodiments of the present invention will be best understood by reference to the drawings, wherein like parts are designated by numerals throughout. It will be readily understood that the components of the present invention, as generally described and illustrated in the figures herein, could be arranged and designed in a wide variety of different configurations. Thus, the following more detailed description of the embodiments of the insect repelling apparatus and/or method of the present disclosure, as represented in figures, is not intended to limit the scope of the invention as claimed, but is merely representative of presently preferred embodiments of the present invention.

According to one aspect of the present disclosure, a method for repelling insect in a defined area or space free from using any chemical entities or composition is offered. Particularly, the disclosed method employs electromagnetic wave radiation of specific spectrum and/or frequency to deter insects such as mosquitoes from entering or flying through the defined area or space subjected to the radiation. The spectrum and/or frequency of the electromagnetic wave to be utilized in the disclosed method is preferably dependent on the environmental lighting condition of the defined area or space to optimally ward off the target insect from closing in, entering into, or almost entering into the defined area or space. Preferably, the disclosed method comprises the steps of providing an electromagnetic radiation generating module comprising a first radiation source capable of emitting a first electromagnetic wave, the first electromagnetic wave being an infrared in the wavelength of 700 nm to 1 mm, an ultraviolet in the wavelength of 10 nm to 400 nm or a spectrum-specific visible light in the wavelength of 490 to 580; and subjecting the defined area or space to a radiation using the first electromagnetic wave. Preferably, the radiation is pulsed at a predetermined frequency to interfere, disrupt and/or disorient perception of the mosquitoes in the irradiated area or space. Further, the type of electromagnetic wave employed in the present disclosure is according to a lighting condition of the defined area or space. For instance, the lighting condition can be one of absence and presence of an environmental visible light. It is important to note that mosquitoes resorts to carbon dioxide, odor, host movement and heat for locating its host or prey. Visual and heat perception of the environment are important aspects of mosquito behavior in all life stages. It was found by inventors of the present disclosure that behavior of the mosquitoes can be changed by manipulating light and/or heat perception of the mosquitoes towards a defined area or space using electromagnetic wave radiation. More importantly, pulsing the radiation of the infrared in the wavelength of 700 nm to 1 mm, the ultraviolet in the wavelength of 10 nm to 400 nm or the spectrum-specific visible light in the wavelength of 490 to 580 nm towards the area or space at the predetermined frequency has shown greater efficiency especially in disorientating the fly path and/or diminishing the mosquitoes' host-finding capabilities within the irradiated area. For instance, when the first electromagnetic wave in the disclosed method is an infrared in the wavelength of 700 nm to 1 mm, the radiation of infrared delivered in the pulsing manner through the disclosed method is designed to disrupt, confuse and/or disturb perception of the mosquitoes with regard to visual and body heat generated by the human subject. Particularly, the antennae of mosquitoes carry heat-sensitive molecular receptors which are crucial in initializing heat-evoked behaviors of mosquitoes. Through pulsation of the infrared within a range predetermined frequency, the disclosed method sends out repetitive or recurring false signals to the mosquitoes presented within or around the irradiated space. The false signal subsequently leads to flight path disorientation and distraction towards the human subject on the part of affected mosquitoes. The defined area or space irradiated by infrared is literally shielded from being perceived or sensed clearly by the mosquitoes via the heat-sensitive receptors thus creating a zone protecting any human subject staying within the defined area. Another electromagnetic wave spectrum being employed in the present method for adversely affecting the mosquitoes in the defined area or space is spectrum-specific visible light in the wavelength of 490 to 580 nm of which the compound eyes of the mosquitoes exhibit highest sensitivity. The disclosed method works on a mechanism slightly different from the infrared radiation for repelling or negatively affecting the mosquitoes with the employment of the spectrum-specific visible light. In one aspect, the inventors of the present disclosure believe that, owing to its high sensitivity towards the visible light at the wavelength of 490 to 580 nm, the mosquitoes exposed to the visible light of this specific spectrum at a predetermined intensity or ‘dosage’ unavoidably have its visual perception of the mosquitoes overstimulated or overloaded. The overstimulation can at least partly confuse or block visual perception of the mosquitoes interrupting and/or disorientating their flight path in the defined area or space irradiated with the visible light at the wavelength of 490 nm to 580 nm. Furthermore, pulsation of the spectrum-specific visible light within the defined space or area may cater the like false signal, as explained in the foregoing for infrared radiation, towards around mosquitoes. The false signal corresponds to false movement and/or activities in the irradiated space distracting the around mosquitoes from locating the actual target. Also, in the absence of any eyelid, the false signal beamed in the form of radiation will be inevitably registered by the mosquitoes confusing its visual perception for detecting, locating and/or sensing the target. The affected mosquitoes may not be able to properly target the potential host, and are likely to be driven off from the irradiated defined area or space to shun the overstimulation imposed to them. As such, the radiation, preferably being delivered in a pulsing fashion, backed by the visible light at the wavelength of 490 to 580 nm used in various embodiments of the present disclosure allows forming of an area or zone in which the mosquitoes will be repelled. Likewise, most mosquitoes exhibit higher sensitive with respect to the UV light of the 10 nm to 400 nm wavelength range. Under a predetermined peak irradiance or intensity, the UV light can disorient the flight pattern of the mosquitoes in a way similar to the aforesaid spectrum-specific visible light. Therefore, in several embodiments, the disclosed method can rely upon the radiation of UV light at the defined area or space for driving the mosquitoes off. Likewise, the UV light-based radiation is preferably carried out in a pulsing manner within a range of predetermined frequency.

According to a number of embodiments, the disclosed method may apply a specific first electromagnetic wave to the defined area or space in relation to the lighting condition of the defined area or space to yield optimal repelling effect while causing minimal disturbance or annoyance to the human subject within or around the defined area or space. More specifically, the first electromagnetic wave used in the disclosed method can be the infrared in the absence of the environmental visible light. Since infrared is not visually perceivable by the eyes of any human subject, irradiation of the infrared towards the defined area or space shall not visually provoke any human subject located inside or around the defined area or space. For example, the infrared can be implemented in the disclosed method to create a mosquitoes-repelling zone in a bedroom specifically shielding the sleeping area from the mosquitoes yet the infrared irradiation results no adverse impact against sleeping pattern of the user or human subject. Also, UV light can be the first electromagnetic wave applicable in the disclosed method to deliver the like result for establishing a mosquitoes-free area in night time or an environment at which the visible light is substantially absent or lack of. Nevertheless, the present method preferably directs the UV to an area where low or no active human activities. Long period exposure to the UV light can be harmful to human subject. The UV light may be provided to potential breeding sites such as small pond, construction site or ditches at the night time or in the absence of daylight to prevent oviposition thereby. Inventors of the present disclosure believe that beaming the radiation of UV, or probably the spectrum-specific visible light, in the flickering or pulsing fashion to the defined space in the absence of daylight may lead to interruption against rhabdoms calibration at the mosquitoes' compound eyes. The compound eyes of the affected mosquitoes may be difficult or unable to adapt a superposition configuration to gather more light in the dark to better locate the potential human host. With the vision at least partly and temporarily impaired in the dark, the mosquitoes are likely to leave the irradiated area or space. Furthermore, the first electromagnetic wave in the disclosed method is preferably the spectrum-specific visible light when the lighting condition corresponds to the presence of the environmental visible light. As stated above, radiation of the visible light at the wavelength of 490 to 580 nm can easily be perceived by mosquitoes due to higher perception on the part of mosquitoes' ommatidia with regard to the visible light of this specific spectrum. For instance, the mosquitoes may be able to close in when the human subject is standing or resting under a shaded area that luminosity or peak irradiance of the visible light at the wavelength of 490 to 580 nm is low but not entirely blocked or withdrawn. The disclosed method emits, preferably in a pulsing fashion within a range of predetermined frequency, the visible light of 490 to 580 nm in wavelength of a predetermined or minimal intensity, peak irradiance or luminosity to a given area or space preferably covering body parts of the human subject to ward off the mosquitoes. The pulsing radiation of the visible light in the spectrum of the wavelength 490 to 580 nm delivered by the disclosed method ensures constant protection is offered to the user despite relatively poor or weak surrounding visible light. In addition to UV and spectrum-specific visible light, the infrared radiation is applicable also in the like situation to create a mosquito-free zone. The radiation of infrared can be directed to the user to offer the best protection, while the radiation of the spectrum specific light is preferably aimed to the body part of the user sought for protection and avoid direct contact with the eyesight of the user.

Pursuant to other embodiments of the present method, the electromagnetic radiation generating module may carry more than one radiation source to provide all-day protection for the user that the disclosed method can switch between a day mode in the presence of visible light and a dark mode associated to absence of any visible light or daylight. To effectuate the all-day protection, the electromagnetic radiation generating module in several embodiments further comprises a second radiation source capable of emitting a second electromagnetic wave which is different from the first electromagnetic wave. Still, the second electromagnetic wave can be any one of an infrared in the wavelength of 700 nm to 1 mm, an ultraviolet in the wavelength of 10 nm to 400 nm or a spectrum-specific visible light in the wavelength of 490 to 580 nm, as long it covers a spectrum different from the first radiation source. The first and second radiation source can be integrated into a single operable system or two separate components working independently to offer enhanced protection. Accordingly, the disclosed method may further comprise a step to switch the radiation from using the first electromagnetic wave to the second electromagnetic wave or vice versa according to the lighting condition. In a few embodiments, the first electromagnetic wave is the spectrum-specific visible light in the wavelength of 490 nm to 580 nm and the second electromagnetic wave is the infrared that the disclosed method may switch the derived radiation from the first radiation source to the second radiation source in relation to changes in the lighting condition from presence to absence of the surrounding or environmental visible lights, and vice versa. In order to smoothen the switching step, the disclosed method is configured to carry out the step of sensing the presence or absence of the environmental visible light and subsequently performing the switching following the information gathered from the sensing. The sensing step can be conducted simply using a photoresistor that its resistance properties vary in response to the surrounding lighting condition. It is possible that the sensing threshold for the disclosed method to discern presence or absence of environmental visible light can be regulated or modified through the photoresistor. Despite the foregoing description, the use of infrared and/or UV radiation in the present disclosure are not restricted to the lighting condition at which the visible light is absent or weakened. Still, it is possible to implement infrared and/or UV radiation preferably within the wavelength of 490-580 nm to the targeted area even in the presence of daylight or visible light to repel or deter the mosquitoes when there are such needed. The radiation from the near infrared and/or near UV in addition to the daylight can facilitates repelling of the mosquitoes in the condition which the intensity of the day light is too low or weak to actually disrupt heat and/or visual sensors of the mosquitoes with respect to the targeted area.

For a number embodiments, the disclosed method delivers the radiation, either from the first or the second radiation source, in a pulsing or flickering fashion to yield greater interference or disruption against visual perception of the mosquitoes. The pulsing or flickering of the electromagnetic wave radiation is performed at a predetermined frequency which cannot be too low until creating a gap wide enough for the mosquitoes to close in on the user. Preferably, the predetermined frequency is at least 0.167 hertz which corresponds to the time required for the mosquitoes to approach a target from sensing to closing in. The inventors of the present disclosure found that the pulsing radiation is more effective in disorientating the flight pattern or path of the mosquitoes while reducing the power consumption of the disclosed method. Still, it is possible to attain the like pulsing effect of the radiation at the predetermined frequency from the first or the second radiation by way of rotating the first or the second radiation source respectively. The rotational frequency of the first and the second radiation sources can be varied to achieve the alike pulsation effect according to the number of each first and second radiation sources available, the circumferential distance round the rotational axis of each first and second radiation sources, physical arrangement of the radiation source, etc.

In order to affect or repel the mosquitoes within the defined area or space, the radiation has to be in sufficient luminosity, peak irradiance or intensity to disrupt visual perception of the mosquitoes. The first and/or second radiation source has an intensity of at least 0.2 to 3 watt power. Preferably, the disclosed embodiments having intensity greater than 3 watt power are set to drain its power from electrical grid. For a few embodiments, the desired peak irradiance, intensity or luminosity can be arrived by combining two or more similar radiation source to increase the total output of the radiation. Consequently, in these embodiments, the electromagnetic radiation generating module may further comprise a third radiation source capable of emitting a third electromagnetic wave that the third electromagnetic wave is similar to the first or second electromagnetic wave. Though not necessary, the third electromagnetic wave preferably has peak irradiance greater than or corresponding to the first or second electromagnetic wave. With the greater combined output, the disclosed method permits creation of a wider or larger protection area or space when there is such need.

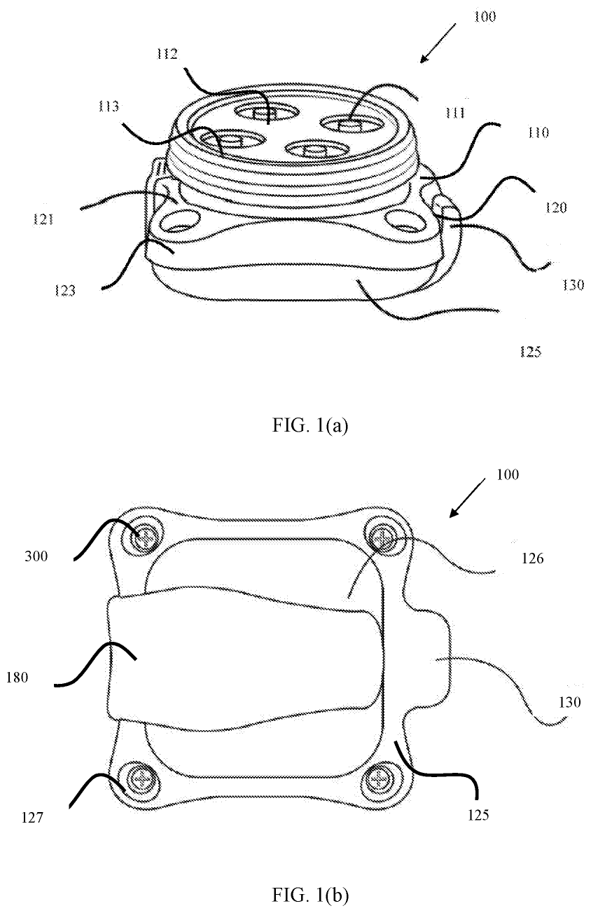

Another major aspect of the present disclosure relates to an apparatus 100 for repelling insect such as mosquitoes in a defined area or space. The disclosed apparatus 100 is operable substantially based upon the abovementioned method. Likewise, the defined area or space referred is associated with a lighting condition, preferably an environment lighting condition in relation to the place where the disclosed apparatus 100 is positioned. The surrounding or environmental lighting condition can be one of the external factors referred by the disclosed apparatus 100 in deciding the best possible mode or configuration to repel the mosquitoes. As illustrated in FIGS. 1(a), 1(b), 2 and 3, the disclosed apparatus 100 essentially comprises a housing 120; an electromagnetic radiation generating module 120 having a first radiation source 111 being capable of emitting a first electromagnetic wave and arranged on the housing 120 such that the electromagnetic radiation generating module 110 uses the first electromagnetic wave to provide a radiation to the defined area or space; and a controller module 160 residing within the housing 120 to electronically communicate with and control the electromagnetic radiation generating module 110. Preferably, the controller module is configured to have the radiation pulsing at a predetermined frequency to effectuate the mosquitoes repelling effect. For some embodiments, the first radiation source can be rotated to create a pulsation effect of the radiation at the predetermined frequency. The rotational frequency of the first radiation source can be similar to or different from the predetermined frequency as long the pulsation effect towards the mosquitoes may correspond to or almost correspond to the predetermined frequency. In the preferred embodiments, the first electromagnetic wave can be one of an infrared in the wavelength of 700 nm to 1 mm, an ultraviolet in the wavelength of 10 nm to 400 nm or a spectrum-specific visible light in the wavelength of 490 to 580 nm. Efficiencies of the disclosed apparatus 100 in warding off the insect or mosquitoes with minimal disruption towards human subject are largely associated to the implementation of the mentioned specific spectrum in connection to the pulsing frequency. Nevertheless, the implementation of the radiation using the preferred electromagnetic wave type according to the lighting condition can result in better performance and efficiency. Specifically, the disclosed apparatus 100 may effectuate the insect or mosquitoes repelling activities by way of directing the radiation towards the defined area or space preferably using the infrared in the absence of an environmental visible light or using the spectrum-specific visible light in the presence of the environmental visible light. The utilization of the infrared or ultraviolet in the dark allows the mosquitoes to be repelled free from any significant unpleasant experience inflicted to the human subject during the night time especially when the human subject or user is sleeping. On the other hand, the spectrum-specific visible light in the wavelength of 490 nm to 580 nm can be used at day time blending into environmental visible light such as daylight to protect user from being bitten by mosquitoes particularly at shaded area with weakened daylight.

As in the embodiment shown, the housing 120 of the disclosed apparatus 100 can be assembled from two separate pieces, a top part 121 and a bottom part 125. Both parts 121, 125 are a tray-like structure. The bottom part 125 has a planar base 126 with upwardly extending sidewalls and four threaded passages 127 arisen from the corner around the planar base 126. The top part 121 has a substantially top curved surface fabricated with a planar opening 122 encompassed by an uprising edge 129, downwardly extending sidewalls and four through passages 123 placed equidistantly around the corners of the curved surface. Each of the threaded passage 127 has an external opening smaller than the inner opening, the inner opening corresponds to the diameter of the through passage 123. By matching the rim of the sidewalls of the top 121 and bottom parts 125, the through passages 123 of the top part 121 become aligned with the threaded passages 127 of the bottom part 125 that drilling a screw 300 of compatible size into each paired through passage 123 and threaded passage 127 results in fastening of the top 121 and bottom parts 125 to form the housing 120, in which a void space is defined for storing and safekeeping of other components of the disclosed apparatus 100.

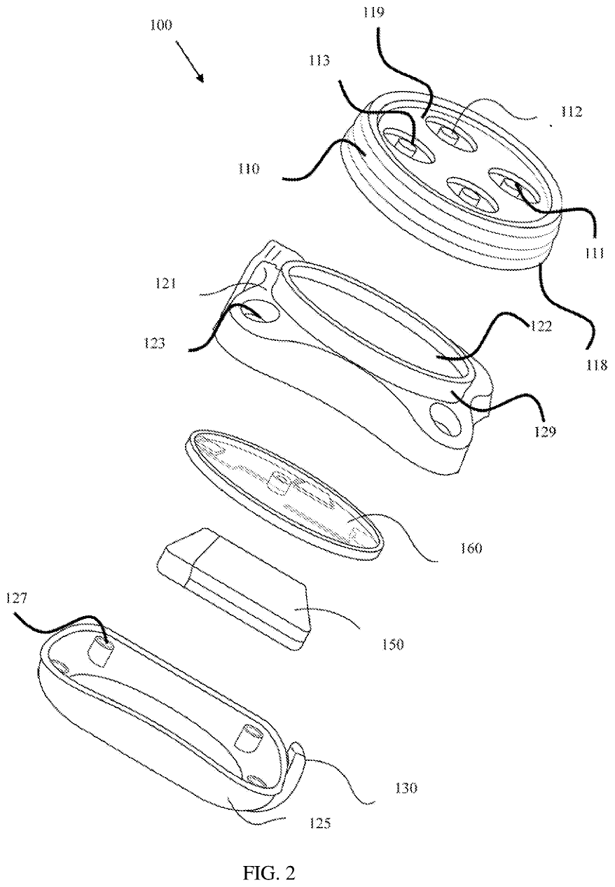

One embodiment of the electromagnetic radiation generating module 110 is illustrated in FIGS. 1(a), 1(b) and 2. Essentially, the electromagnetic radiation generating module 110 comprises the first radiation source 111 being capable of emitting a first electromagnetic wave and arranged on the housing 120 such that the electromagnetic radiation generating module 110 uses the first electromagnetic wave to provide a radiation to the defined area or space as described in the foregoing. Other embodiments, as illustrated in the referred figures, may have more than one radiation source besides the first radiation source 111 to enhance usability of the disclosed apparatus 100 in creating a mosquitoes-free space or area. Accordingly, the electromagnetic radiation generating module 110 in some embodiment comprises a second radiation source 112 capable of emitting a second electromagnetic wave. The second electromagnetic wave is preferably different from the first electromagnetic wave. Particularly, the second electromagnetic wave can be any one of infrared in the wavelength of 700 nm to 1 mm, an ultraviolet in the wavelength of 10 nm to 400 nm and a spectrum-specific visible light in the wavelength of 490 to 580. Preferably, the electromagnetic radiation generating module 110 emits the electromagnetic wave in a pulsing or flickering manner which is managed or regulated by the controller module 160 to have the radiation pulsing at a predetermined frequency to attain the mosquitoes repelling effect. As mentioned above, it is possible to attain the like pulsing effect of the radiation at the predetermined frequency from the first or the second radiation by way of rotating the first or the second radiation source respectively. The rotational frequency of the first and the second radiation sources can be varied to achieve the alike pulsation effect according to the number of each first and second radiation sources available, the circumferential distance round the rotational axis of each first and second radiation sources, physical arrangement of the radiation sources in relation to one and other on the housing, etc. Referring to FIGS. 1(a), 1(b) and 2, the electromagnetic radiation generating module 110, with multiple radiation sources 111/112/113, includes a substantially flat top face 119 made of transparent material, a plurality of radiation sources 111/112/113 being arranged underneath of the top face 119 to beam the radiation through the transparent top face 119 unhindered, a slanting side surface to define a base 118 having diameter larger than the transparent top 119. The transparent top face is sized to have a diameter fitting the diameter of the planar opening 122 of the housing 120 that the upper portion of the electromagnetic radiation generating module 110 can be snugly inserted into the raised edge 129 around the planar opening to fix the electromagnetic radiation generating module 110 to the housing 120. The enlarged base 118 of the electromagnetic radiation generating module 110 prohibits the module 110 from falling out of the housing 120 through the planar opening 122.

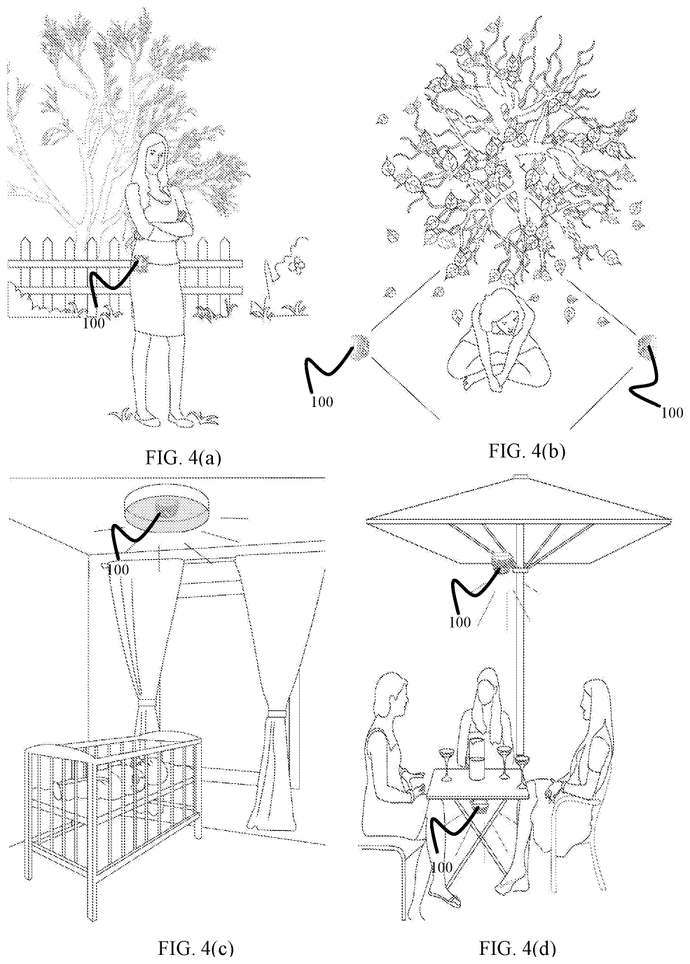

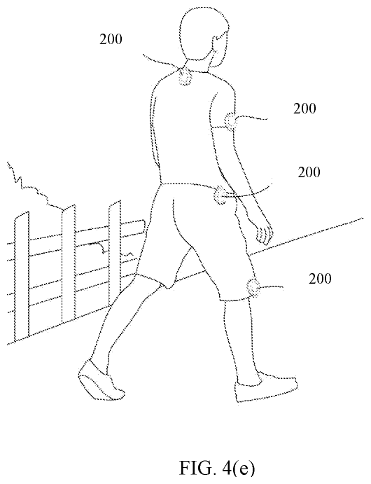

Having at least two different types of radiation sources 111/112/113, the versatility of the disclosed apparatus 100 in these embodiments can be significantly improved. Like stated in the earlier description, the employment of infrared in the wavelength of 700 nm to 1 mm shields the space and other object in that particular space from being perceived or seen by the mosquitoes by disrupting heat sensing capability of the mosquitoes, while the spectrum-specific visible light in the wavelength of 490 to 580 nm is prone to overloading and/or distracting the visual perception of the mosquitoes hence interrupting or disorientating flight path of the mosquitoes within the irradiated area or space and finally driving the mosquitoes away from the irradiated area. The UV light can disorientate the flight pattern of the mosquitoes causing host targeting become difficult for the affected mosquitoes in a fashion similar to the spectrum-specific visible light under a predetermined peak irradiance, luminance or intensity. By combining an infrared radiation source as the first radiation source 111 and a spectrum-specific visible light radiation source as the second radiation source 112 into the electromagnetic radiation generating module 110, the disclosed apparatus 100 can provide all-day protection for the user. More specifically, the disclosed method can switch between a day mode in the presence of visible light and a dark mode associated to the absence of any visible light or daylight. For example, the day mode operating based upon the spectrum-specific visible light can be switched on for daily outdoor activities such as strolling in a shaded park or having picnic under the tree as respectively depicted in FIG. 4(a) and FIG. 4(b). In FIG. 4(a), the user straps one embodiment of the disclosed apparatus 100 around the waist beaming the spectrum-specific visible light downwards to have the lower body part protected from the mosquitoes or insects. For FIG. 4(b), the disclosed apparatus 100 can be placed around the user to create a harmless radiation of the spectrum-specific visible light encompassing the user and multiple copies of the disclosed apparatus 100 may be deployed to get better coverage. The disclosed apparatus 100 can adaptably shift into a dark mode using either infrared or ultraviolet though infrared is more preferable for application with human subjects involved as shown in FIGS. 4(c) and 4(d). The dark mode of the disclosed apparatus 100 lights up the infrared to create a veil of infrared shielding the human subjects such as vulnerable sleeping infant from being detected or sensed by the mosquitoes as seen in the illustration of FIG. 4(c). Similar principle can be used for installing the disclosed apparatus 100 at an outdoor dining restaurant especially under the table or canopy to form a blanket of infrared to fence the mosquitoes from approaching the irradiated area. It is important to note that the disclosed apparatus 100 can be integrated into common lighting system or devices used in household or office. The integrated apparatus can be switched on manually or automatically to provide the needed protection against mosquitoes.

To fully automate the switching between the first 111 and second radiation sources 112 to match the environmental lighting condition, the disclosed apparatus may possess a sensor (not shown) being configured to detect the presence or absence of the environmental visible light and subsequently switch to use the correct radiation source following the information gathered by the sensor. This feature can come in handy when the disclosed apparatus is being seamlessly incorporated into the existing lighting system such as indoor down lights assembled to the ceiling of a house or an office. The sensor can be a photoresistor that its resistance properties vary in response to the surrounding lighting condition. For example, the sensor prompts the controller module 160 to switch on the second radiation source 112 for providing the spectrum-specific visible light in the wavelength of 490 to 580 nm when the down light is on. The spectrum-specific visible light blends into the down lights to form a mosquito repelling field or space. Otherwise, in the absence of the down light, the sensor relays the detected information to the controller module 160 to bring forth radiation of the infrared derived from the first radiation source 111. It is possible that the sensing threshold of the disclosed apparatus to discern presence or absence of environmental visible light can be regulated or modified through the photoresistor. In short, radiation originated from the disclosed apparatus 100 is switchable from using the first electromagnetic wave to the second electromagnetic wave or vice versa through the controller module according to the lighting condition determined or identified by the sensor.

In order to deter or shield the mosquitoes from entering the defined area or space, the disclosed apparatus 100 must supply the radiation in sufficient luminosity, peak irradiance or intensity to successfully disrupt visual perception of the mosquitoes. Preferably, the first and/or second radiation source has an intensity of at least 0.3 to 3 watt power. Other embodiments of the present disclosed apparatus 100 can have the electromagnetic radiation generating module 110 comprised a third radiation source 113 capable of emitting a third electromagnetic wave in a way similar to the first 111 and/or second radiation source 112. Preferably, the third electromagnetic wave is similar to the first or second electromagnetic wave and the third electromagnetic wave has peak irradiance greater than or corresponding to the first or second electromagnetic wave. With the third radiation source 113 provided thereby, the disclosed apparatus 100 of such embodiments can derive the desired peak irradiance, intensity or luminosity by combining two or more similar radiation source to increase the total output of the radiation. In line with the presence of the third radiation source 113, the radiation or radiation output provided through the disclosed apparatus 100 is switchable from using the first, second or third electromagnetic wave solely, or a combination of the third with the first or second electromagnetic waves concurrently based upon the electric signal or arrangement on the controller module 160. The higher output attained allows greater space or area to be covered by the present disclosed apparatus 100. Moreover, the disclosed apparatus 100 may house four or more individual radiation source with at least a pair of the radiation sources capable to emit electromagnetic wave of similar spectrum or type as shown in FIGS. 1(a), 1(b) and 2.

Again referring to FIG. 2, the disclosed apparatus 100 includes a battery pack 150 stored inside the assembled housing 120. In few embodiments, the battery pack 150 is laid within the bottom part of the housing 120. The battery pack 150 is preferably being held among and secured by the four uprising threaded passages 127. The disclosed apparatus 100 further has the controller module 160 sandwiched between the battery pack 150 and the electromagnetic wave generating module 110 that the top face of the controller module 160 at least partly abuts onto the bottom of the electromagnetic wave generating module 110. One or more contact points (not shown) between the modules 110, n160 and the battery pack 150 are established for powering up the radiation source 111/112/113 and communication between the controller module 160 and electromagnetic wave generating module 110. These contact points can be further effectuated using wires and/or metal strips lined inside the housing 120 for electrically connecting the modules 110, 160 and the battery pack 150. In addition to that, a button or switch 130 moveable between at least an ON position and an OFF position is fabricated exterior to the housing 120. For the illustrated embodiment in FIG. 2, the button or switch can be moved laterally in relation to the housing 120 or pressed sequentially to call upon various features of the disclosed apparatus 100 including switching the radiation source 111/112/113 on and off, selecting the preferred radiation source 111/112/113, combining multiple radiation sources 111/112/113 and etc.

Pursuant to another preferred feature of the disclosed embodiments, the controller module 160 in the described apparatus 100 is configured to have the radiation pulsing at a predetermined frequency. The inventors of the present disclosure found that the pulsing radiation is more effective in disorientating the flight pattern or path of the mosquitoes inside the space or area subjected to the radiation while reducing the power consumption of the disclosed apparatus 100 as mentioned in the foregoing description. The pulsing or flickering fashion of the radiation tends to yield greater interference or disruption against heat and/or visual perception of the mosquitoes. The pulsing or flickering of the electromagnetic wave radiation is performed at a predetermined frequency of at least 0.167 hertz which corresponds to the time required for the mosquitoes to approach a target from sensing to closing in. Any pulsing or flickering frequency below or lower than the predetermined frequency is likely to create a gap wide enough for the mosquitoes to close in on the user defying the object set out to repel off the mosquitoes from the user.

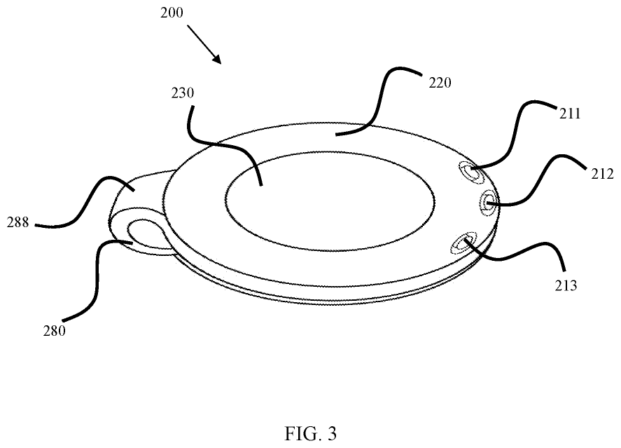

In FIG. 3, another embodiment of the disclosed apparatus 200 is revealed. Particularly, the housing 220 is an oval flatten piece on which a plurality of radiation sources 211/212/213 are positioned and spaced apart around at the circumference. The housing 220 bears a resiliently pressable button 230 on one of its planar surface. Pressing the button 230 in a sequential fashion shall bring forth different preset radiations pattern configured to the controller module (not shown), which resides within the housing 220. The referred embodiments may have a fastening member 280 fabricated on the housing 220 and configured to allow attachment or positioning of the fastening member 280 to a platform for providing the radiation constantly. The fastening member 280 in the embodiment of FIG. 3, is a clipping or clamping construct, extending along the planar surface opposite to the pressable button 230, attaching to the circumference of the oval housing 220 through a resilient hinge 288 at a position substantially opposite to the position of the circumference carrying the radiation sources 211/212/213. Through the relative arrangement of the fastening member 280 and the radiation sources 211/212/213 on the housing 220, the disclosed apparatus 200 can be portably attached to the clothing of the user or human subject aiming the radiation, preferably in a downward manner with minimal impact on the user eyesight, towards a body part of the user to be protected as depicted in FIG. 4(e). Specifically, FIG. 4(e) shows different locations at which the disclosed apparatus 200 can be removably attached to cover the desired body part with the radiation. One or more of the disclosed apparatus 200 can be used simultaneously to cover different body parts. Moreover, the radiation sources 211/212/213 can be adaptably arranged on housing 220 to emit radiation beam at wider angle covering greater space.

Further aspect of the present disclosure may direct to the application of the described apparatus 100/200 in disrupting sensor or sensing devices generally used for detecting presence of an object such as human and/or movement of such object based upon innate electromagnetic radiation emitted or generated from the targeted object. The aforesaid sensors or sensing devices include night vision google mostly operable in the near IR spectrum at the wavelength ranging from the 0.8 μm to 1.7 μm, thermal vision camera operable in the mid IR spectrum at the wavelength ranging from 7 μm to 13 μm, UV vision camera for collecting data using the UV spectrum of 10 nm to 400 nm and the like. To effectuate the disruption towards the sensors, it is important for the disclosed apparatus to pulse the radiation or by way of rotating the radiation source using the electromagnetic wave matching to the type implemented in the sensor. For example, it is preferable to disrupt functionality of the night vision google through emission of the near IR radiation but not radiation from the UV spectrum. More particularly, the method for disrupting a sensing device for collecting data relating to a predetermined type of electromagnetic radiation within a defined area comprising the step of providing a radiation source capable of emitting a disruptive electromagnetic wave corresponding to the predetermined type of electromagnetic radiation; and irradiating the disruptive electromagnetic wave towards the defined area and/or the sensing device at an intensity sufficient to cause oversaturation in the sensing device, wherein the electromagnetic radiation is of the spectrum of infrared and ultraviolet free from visible light. For more preferable embodiments, the irradiation is performed in a pulsing manner in relation to the sensing device. The pulsation effect can be achieved by way of pulsing or rotating the radiation source through a control module. In other embodiments, it is possible to specifically target a given type of sensing devices according to the thermal time constant while leaving the rest of the sensing devices around the defined area uninterrupted. Particularly, the pulsation effect generated can be programmed in a fashion or at a frequency to only create a constant disruption or unstable state in the sensor of the targeted sensing device based upon the thermal time constant of the sensor. For instance, the pulsation of the disruptive electromagnetic wave can be adjusted at a frequency high enough to affect the targeted sensing device with relatively high thermal time constant but insufficient to result unsteady state in those sensing devices not being the targets.

One skilled artisan in the field shall appreciate the fact that the like disruption shall be applicable as well towards similar sensor or camera installed on armed drones and robots aiming to at least temporarily disable normal functionality of the armed drones and robots.

Aspects of particular embodiments of the present disclosure address at least one aspect, problem, limitation, and/or disadvantage associated with existing insect or mosquitoes repelling method and apparatus. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

What is claimed is:

1. A method for repelling insects in a defined area or space, comprising:
providing an electromagnetic radiation generating module comprising a first radiation source capable of emitting a first electromagnetic wave, the first electromagnetic wave being an infrared in the wavelength of 700 nm to 1 mm, an ultraviolet in the wavelength of 10 nm to 400 nm or a spectrum-specific visible light in the wavelength of 490 nm to 580 nm; and
subjecting the defined area or space to a radiation using the first electromagnetic wave according to a lighting condition of the defined area or space, the lighting condition being one of absence and presence of an environmental visible light,
wherein the radiation is pulsed at a predetermined frequency or the first radiation source is being rotated to create a pulsation effect of the radiation at the predetermined frequency.

2. The method of claim 1, wherein the electromagnetic radiation generating module further comprises a second radiation source capable of emitting a second electromagnetic wave that the second electromagnetic wave is different from the first electromagnetic wave, the second electromagnetic wave is an infrared in the wavelength of 700 nm to 1 mm, an ultraviolet in the wavelength of 10 nm to 400 nm or a spectrum-specific visible light in the wavelength of 490 nm to 580 nm.

3. The method of claim 2, further comprising switching the radiation from using the first electromagnetic wave to the second electromagnetic wave or vice versa according to the lighting condition.

4. The method of claim 1, wherein the first electromagnetic wave is the infrared or ultraviolet in the absence of the environmental visible light or the first electromagnetic wave is the spectrum-specific visible light in the presence of the environmental visible light or in environment where we do not need to consider the electromagnetic wave affecting human eyes.

5. The method of claim 1, wherein the predetermined frequency is at least 0.167 hertz.

6. The method of claim 2, wherein the first and/or second radiation source has an intensity of at least 0.2 to 3 watt.

7. An apparatus for repelling insects in a defined area or space having a lighting condition, comprising:
a housing;
an electromagnetic radiation generating module having a first radiation source being capable of emitting a first electromagnetic wave and arranged on the housing such that the electromagnetic radiation generating module uses the first electromagnetic wave to provide a radiation to the defined area or space; the first electromagnetic wave being an infrared in the wavelength of 700 nm to 1 mm, an ultraviolet in the wavelength of 10 nm to 400 nm or a spectrum-specific visible light in the wavelength of 490 nm to 580 nm; and
a controller module residing within the housing to electronically communicate with and control the electromagnetic radiation generating module,
wherein the controller module is configured to have the radiation pulsing at a predetermined frequency or the first radiation source is being rotated to create a pulsation effect of the radiation at the predetermined frequency.

8. The apparatus of claim 7, wherein the electromagnetic radiation generating module further comprises a second radiation source capable of emitting a second electromagnetic wave that the second electromagnetic wave is different from the first electromagnetic wave, the second electromagnetic wave is infrared in the wavelength of 700 nm to 1 mm, an ultraviolet in the wavelength of 10 nm to 400 nm or a spectrum-specific visible light in the wavelength of 490 to 580 nm.

9. The apparatus of claim 7, wherein the electromagnetic radiation generating module further comprises a third radiation source capable of emitting a third electromagnetic wave that the third electromagnetic wave is similar to the first electromagnetic wave and the third electromagnetic wave has peak irradiance greater than or corresponding to the first electromagnetic wave.

10. The apparatus of claim 8, wherein the radiation is switchable from using the first electromagnetic wave to the second electromagnetic wave or vice versa through the controller module according to the lighting condition.

11. The apparatus of claim 9, wherein the radiation is switchable from using the first electromagnetic wave, the third electromagnetic wave, or the first and third electromagnetic waves concurrently through the controller module.

12. The apparatus of claim 7, wherein the radiation facilitates insect repelling in the defined area or space using the infrared or ultraviolet in the absence of an environmental visible light or using the spectrum-specific visible light in the presence of the environmental visible light.

13. The apparatus of claim 7, wherein the predetermined frequency is at least 0.167 hertz.

14. The apparatus of claim 7, wherein the first and/or second radiation source has an intensity of at least 0.2 to 3 watt.

15. The apparatus of claim 7, further comprising a fastening member fabricated on the housing and configured to allow attachment or positioning of the fastening member to a platform for providing the radiation.
